(19) United States
(12) Patent Application Publication
(10) Pub. No.: US 2020/0169196 A1
(43) Pub. Date: May 28, 2020

(54) Electric propulsion system

(71) Applicant: Valentin Grigoryevich LIMANSKIY, pgt. Mendeleevo (RU)

(72) Inventor: Valentin Grigoryevich LIMANSKIY, pgt. Mendeleevo (RU)

(21) Appl. No.: 16/609,935

(22) PCT Filed: Nov. 8, 2017
(86) PCT No.: PCT/RU2017/000833

§ 371 Date: Oct. 31, 2019

(30) Foreign Application Priority Data
Jun. 1, 2017 (RU) 2017119201

(51) Int. Cl. H02N 11/00; H02K 53/00

(52) U.S. Cl. CPC H02N 11/008; H02K 53/00

(57) ABSTRACT

The proposed electric propulsion system is designed for generating thrust, improving environmental performance. An embodiment of the system includes three devices, each containing two or more insulated current-conducting plates arranged in parallel and forming an electric capacitor. The capacitors are arranged in a row such that the second electric capacitor is disposed between the first capacitor and the third capacitor. Each capacitor is designed such that at least one charged plate is capable of reciprocating motion. When identically charged plates are moving, their velocities have the same sign. The plates of the first and third capacitors move in a direction toward and away from the second capacitor, and the plates of the second capacitor move in a direction transverse to the direction of movement of the plates of the first and third capacitors. The sign of the velocities of all of the plates changes at the same time.

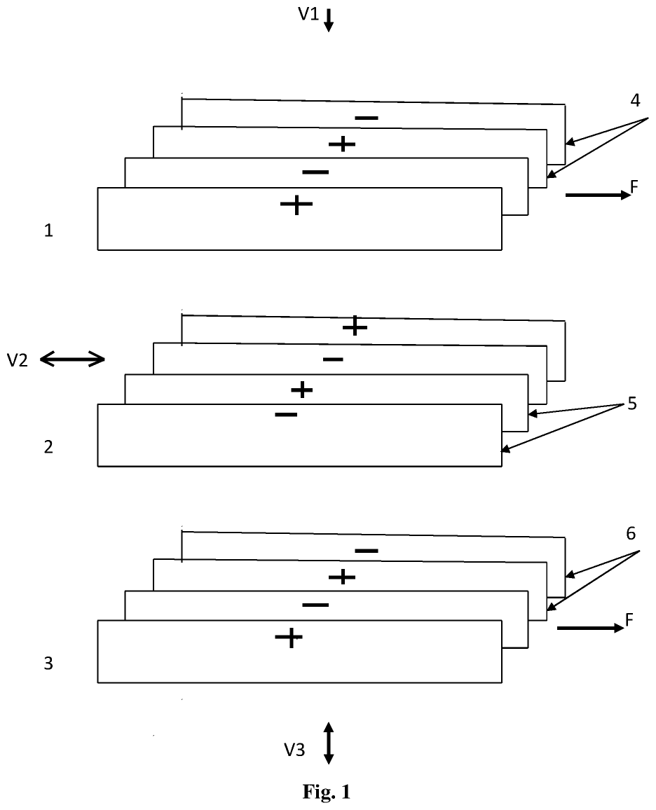

### CROSS-REFERENCE TO RELATED APPLICATIONS

This application is a U.S. national stage application of an international application PCT/RU2017/000833 filed on 8 Nov. 2017, whose disclosure is incorporated herein in its entirety by reference, which international application claims priority of a Russian Federation patent application RU2017119201 filed on 1 Jun. 2017.

### FIELD OF THE INVENTION

This invention relates to the field of electric propulsion engineering and can be used to create thrust which in turn can be used in various devices. An electric propulsor device (herein also called ‘electric propulsion device’ or ‘electric propulsor’) does not need any fuel and combustion chamber for its operation, is ecologically clean and has the potential of application in transportation for propulsion of ground and space vehicles, in power engineering, mechanical engineering, construction industry, space exploration and other technical fields.

### BACKGROUND OF THE INVENTION

Currently the problem is partially solved in practice with the use of combustion motors and jet engines which use fuel for their operation. In combustion engines, fuel explosion in the combustion chamber induces a movement of the piston which is transferred to the wheels, air screws, ship propellers, etc. which results in generation of rotational momentum in them and, for example, of progressive motion of the vehicle, ship, aircraft, etc. In jet engines, fuel explosion in the combustion chamber generates a jet gas stream that exits the chamber and creates jet thrust. Such devices are not ecologically clean. Their radius of operation is limited by fuel capacity which is especially true in the case of jet engines. There are also ideas related to ion jet engines, including those based on Brown effect, but their industrial implementation meets great difficulties.

Therefore, the task of the invention is to get away from all such imperfect fuel machines and use only electromagnetic thrust that occurs in respectively reciprocally moving charged electric surfaces (plates) not necessarily shaped flat, or rectangular.

At present there is a great number of erroneous literature, including patent-literature, devoted to “propulsors” based on electric and/or magnetic interaction of closed electric currents (erroneous literature is not accepted to refer to as it produces no result).

Meanwhile, it is widely known that, for example, in case of interaction of a system including two electrical charges, electrical action of one charge on the other charge is exactly equal in absolute value but opposite in sign: here, the action is equal to the counter-action. That is why in a system consisting of many electrical charges, for example, in any dielectric capacitor, total electric force, acting on such system, equals to zero, and no thrust can arise in such system due to electric forces only.

A similar statement is true for closed electric currents represented as permanent magnets with closed elementary electric currents, or as closed electric currents in coils, or both. This is why in case of interaction of two closed loops with electric current, magnetic force action of one loop on the other is exactly equal in absolute magnitude but opposite in sign: and here, the action is equal to the counter-action.

Thus, no thrust can arise in such electric and/or magnetic systems. This explains the lack of appropriate technical results—commercially available electric propulsion devices.

Thrust can arise in some systems with non-closed electric currents. The present invention is concerned with the subject-matter of electric propulsor.

The propulsor, based on the effect of perpendicularity of magnetic force to electric charge travel velocity, devised by the inventor earlier, is closest to the inventive electric propulsor. The electric propulsor comprises two devices wherein the first device includes two charged bodies (electric charges) moving reciprocally with mutually perpendicular velocities, being in one phase, when return points during the reciprocal movement of the electric charges are synchronized.

The second device is mirroring the first one. All charged bodies are aligned in a row. Since all charged entities undergo cyclic motion, each of them generates magnetic field. Magnetic force action on the moving electric charge is determined in accordance with left-hand rule. Direction of magnetic force is such that forces, created by the charged bodies, directed along a row of these devices, compensate each other while forces, acting crosswise this row, are directed one way and create momentum: here, action is not equal to counter-action (Limanskyi V. G. Unified physical theory of space-time, matter and field. M.: OOO Agrorus Publishers, second edition, 2016, p. 100-103; Limanskyi V. G. Abstract of unified physical theory of space-time, matter and field. Para 4. New type propulsor. http://liman777.ru/upload/slim_teory.htm)—reference [1].

### SUMMARY OF THE INVENTION

The described invention relates to the field of electric propulsion engineering and is aimed at creation of highly efficient device for developing thrust. Thus, the engineering problem, solved by the invention is to create a new ecologically clean electric source of thrust, to broaden the area of application thereof, to reduce costs for building engines, to increase specific power, the efficiency factor and operating radius of the existing motors and jet engines. Thrust, developed by the electric propulsor, can be used in various apparatus.

The aforesaid problem is resolved by using an electric propulsor comprising two or more devices, aligned in a row, each containing two or more insulated conductive plates forming an electric capacitor; wherein each such electric capacitor is adapted to reciprocal movement of one or more of its charged plates, wherein, during the movement of the equally charged plates, their velocities have the same sign, while, during the movement of the oppositely charged plates their velocities differ in sign; wherein two or any two of the electric capacitors positioned adjacently are adapted to reciprocal movement of the plates of a first electric capacitor in a longitudinal direction—toward a second electric capacitor and backward, while the second electric capacitor is adapted to reciprocal movement of the plates in a direction which is transverse to the direction of movement of the plates of the first electric capacitor, out of the two electric capacitors; at that, all the electric capacitors are made in such a manner that the instants of time, when sign of their movement velocity changes, coincide for all the plates.

With all that the above implies, in a particular case, the above mentioned problem is resolved in a first embodiment of the invention, by using an electric propulsor including two electric capacitors, aligned in a row so that the first electric capacitor is adapted to reciprocal movement of its flat plates, each in its plane, in a longitudinal direction to the row—toward the second electric capacitor and backward, while the second electric capacitor is adapted to movement of its flat plates, each in its plane, in a direction transverse to the row.

The above problem is also resolved in a second embodiment of the invention by using an electric propulsor that includes three electric capacitors, aligned in a row so that the second electric capacitor is located between the first and third electric capacitors wherein the first and third electric capacitors are adapted to reciprocal movement of its flat plates, each in its plane, in a longitudinal direction to the row—toward the second electric capacitor and backward, while the second electric capacitor is adapted to reciprocal movement of its flat plates, each in its plane, in a direction transverse to the row.

In a third embodiment of the invention, an electric propulsor includes three electric capacitors, aligned in a row so that the second electric capacitor is located between the first and third electric capacitors wherein the first and third electric capacitors are adapted to reciprocal movement of their flat plates, each in its plane, in a direction transverse to the row, while the second electric capacitor is adapted to reciprocal movement of its flat plates, each in its plane, in a longitudinal direction to the row—toward the first electric capacitor and backward or, which is the same, toward the third electric capacitor and backward.

The distinction of the proposed electric propulsor is in application of reciprocally moving electric charges arising at the plates of an electric capacitor having a greater magnitude instead of application of a single electric charge having a comparatively lesser magnitude. At that, electric action of these charges takes place inside of the electric capacitor and does not expand to outer space.

The result, achieved with the use of this invention as compared to close substitutes allows increasing power and the efficiency factor of the proposed electric propulsor.

When operating the electric propulsor, it is possible, if required, to develop mechanical moment in each transversally moving electric capacitor and thrust—in a longitudinally moving one which, on the whole, depends on values of electrical voltage at plates of the electric capacitors and/or velocities of plate movement and/or distance between the electric capacitors, thus building up thrust of the electric propulsor and value of its rotational momentum.

For example, if the electric propulsor includes more than three electric capacitors, aligned in a row so that alternately arranged the electric capacitors of the first group are adapted to reciprocal movement of their flat plates, each in its plane, in a longitudinal direction to the row, and the electric capacitors of the second group, arranged between them, are adapted to reciprocal movement of their flat plates, each in its plane, in a direction transverse to the row; wherein, separately in the first group and, similarly, separately in the second group, in transition from one electric capacitor to the next one, velocity signs of similarly charged plates alter (for each instant of time). Then all longitudinally moving plates of the first group develop thrust, directed one way, with total mechanical moment in the second group of electric propulsor equal to zero. This assertion follows from left-hand rule.

The described electric propulsor does not use any fuel for its operation and is ecologically clean. It develops thrust in accordingly moving electrically charged surfaces (plates, not necessarily flat) of electric capacitors. Absolute value of electric charge at each plate in the electric capacitor is considerably higher than absolute value of electric charge of a single plate. At that, electric action of these charges takes place inside of electric capacitor and does not expand to outer space. Since the arising magnetic forces are perpendicular to velocities of electric charge movement, they do not interfere with movement of these charges which automatically results in higher efficiency factor of this propulsor. Thus, the above mentioned novelty facilitates considerable increase of operating radius, specific power and the efficiency factor of the proposed electric propulsor, its wider application in industries.

### DRAWING OF THE INVENTION

The attached drawing shows a specific example of the proposed electric propulsor electro-magnetic system.

### PREFERRED EMBODIMENTS OF THE INVENTION

### Example 1

The drawing shows end view of electro-magnetic system of electric propulsor comprising three devices 1, 2 and 3 (according to the second invention variant), aligned in a row: each containing, on top, in the center and below, two or more, aligned parallel, conductive, properly insulated, strong flat plates 4 (5, 6) forming, on the whole, electric capacitor 1 (2, 3). Flat plates 4, 5 and 6 of all electric capacitors are parallel to one plane—vertical in this case. Electric capacitors 1, 2 and 3 are adapted to reciprocal movement of charged flat plates, each in its plane. Wherein, if all flat plates 4 (5, 6) in the said electric capacitor 1 (2, 3) are moving, movement velocities V1 (V2, V3) of its oppositely charged plates differ in sign (direction); plates 4 of electric capacitor 1, located on top, are moving reciprocally and vertically: up- and down. Movement velocities of flat plates 4 and 6 of two electric capacitors 1 and 3, located below and on top, differ in sign while plates 4 and 6 of these capacitors are similar in sign. Otherwise, their velocity signs (directions) are coincident. Movement velocities of flat plates 5 of electric capacitor 2, located in the center, are perpendicular to movement velocities of flat plates 4 of electric capacitor 1, located on top (or, which is all the same, flat plates 6 of electric capacitor 3, located below). Instants of time of backward motion of all moving flat plates 4, 5 and 6 coincide.

In another variant, electric propulsor comprises three electric capacitors 1, 2 and 3 wherein plates 4 and 6 of electric capacitors 1 and 3 are moving right-left (see the drawing) while plates 5 of capacitor 2 are moving up-and-down.

Reciprocal movement of the plates and electric charge at the plates can be adequately realized with the use, for example, by a crankshaft and electrical voltage supply to the plates (not shown).

Certainly, in another specific variant of the invention, the flat plates in the first and/or second and/or third electric capacitor can also be aligned parallel to the horizontal plane.

The described electric propulsor operates in the following way. For operation of the electric propulsor, shown in the drawing, it is necessary, firstly, to supply electrical voltage, respectively, to insulated plates 4, 5 and 6 of three electric capacitors 1, 2 and 3, at the flat plates of which permanent electric charges with “+” or “−” sign are formed, and, secondly, to put flat plates 4, 5 and 6 in reciprocal motion with the use, for example, of crankshaft (not shown). In this variant of the electric propulsor, the value of thrust F and its mechanical moment can be controlled, for example, by regulating value of electric charge at flat plates of said three electric capacitors, velocities of the flat plate movement, change of the distance between the plates, change of spatial attitude of the electric capacitors, etc.

For example, when electric charge at all plates 5 of electric capacitor 2, located in the center, changes, thrust will change its sign as well. This type of electric capacitors, during reciprocal movement of electric charges, generates magnetic field which is used for developing thrust. Thrust direction (Lorentz force) which is generated in moving flat plates 4 and 6 of capacitors 1 and 3, located on top and below, can be easily determined with the use of left-hand rule.

### Example 2

Another variant of electric propulsor without lower or upper electric capacitors can be devised if necessary. In such case, the electric propulsor comprises two electric capacitors, for example, only 1 and 2 (see the drawing disregarding electric capacitor 3). Flat plates 4 and 5 of electric capacitors 1 and 2 are located as in example 1, and electric capacitors 1 and 2 are adapted to the corresponding movement of flat plates 4 and 5, see description of plates in Example 1.

According to the second variant, the electric propulsor operates similarly to the first variant of electric propulsor. Wherein Lorentz forces which arise in moving flat plates 4 and 5 of these two electric capacitors 1 and 2 can also be easily determined with the use of left-hand rule (see reference [1], page 102).

The described electric propulsor can have more than three electric capacitors, aligned in a row (not shown in the drawing). At that, the electric capacitors, located next but one, are adapted to reciprocal movement of their flat plates, each in its plane, in a longitudinal direction to the row while electric capacitors, located between them, are adapted to reciprocal movement of their flat plates, each in its plane, in a direction transverse to the row. Wherein, separately in the first group and, similarly, separately in the second group, in transition from one electric capacitor to the successive one, velocity signs of the equally charged plates alter. Thrust of the electric propulsor is determined by total alternating current which is excited by movement of the electric charges in each electric capacitor. It is possible to excite electric charge of the order of 1 C at each square meter of each plate (left and right of it) (J. Burfoot, G. Taylor. Polar dielectrics and their applications. M.: Mir, 1981, page 44, 191)—reference [2]. If one centimeter can house, for example, four plates (it is easy to achieve), then one meter can house 400 of them with common electric charge in one cubic meter equal to 1 C×400=400 C.

At a maximum velocity of these plates, equal, for example, to 300 m/s, maximum alternating current (passing through cross section of 1 square meter), excited in this capacitor, will be equal to 400×300=120 000 A. Such alternating current of electric capacitor 2, located in the center, will excite magnetic field (acting on two adjacent electric capacitors 1 and 3 with similar electric currents) which is sufficient for industrial application of the electric propulsor, for example, for moving space apparatus. Certainly, for its implementation, materials which are electrically and mechanically ultra strong, for example, with ideal or almost ideal atomic lattice, will be needed such as those used, for example, in electric capacitors and aircraft jet engines. It should be noted that a metal with ideal atomic lattice is, as a rule, stronger than the base metal by two orders of magnitude which ensures good conditions for industrial implementation of this invention.

Such are the basic requirements to design and principle of operation of the electric propulsor. Given examples do not cover and, all the more, do not confine the entire scope of claims of this technical solution and are merely illustrative material of particular variants. For example, the drawing shows plates as rectangular surfaces, parallel to the vertical plane. However, to increase power in electric capacitor 2 it is possible to use vertically arranged, not rectangular, flat plates which additionally bound electric capacitors 1 and 3 from two sides (from flanks) and do not hinder reciprocal (vertical) movement of the latter.

Similarly, in case of horizontally located plates in electric capacitor 2, to increase power it is possible to use surfaces which additionally bound electric capacitor 1 from two sides (from flanks) (on the whole, in the shape of a duct—tray open at one side) and, similarly, electric capacitor 3. In this case half of plates (surfaces) of electric capacitor 2 will additionally bound electric capacitor 1 from sides, and the other half—electric capacitor 3. In this case it is convenient to implement reciprocal movement of the plates of electric capacitor 2 in a direction perpendicular to the drawing.

### INDUSTRIAL APPLICABILITY

Industrial applicability of the electric propulsor was substantiated in the examples. The current level of technology makes it possible to put the electric propulsors of the next level with low, medium and higher power into full production.

1. Electric propulsor device consisting of two or more devices, aligned in a row, each containing two or more insulated conductive plates forming electric capacitor; wherein each electric capacitor is adapted to reciprocal movement of one or more charged plates, and when equally charged plates are moving, velocities of their movement have the same sign while, when differently charged plates are moving, velocities of their movement differ in sign; two or any two adjacent electric capacitors are adapted to reciprocal movement of plates of one electric capacitor in longitudinal direction—toward another electric capacitor and backward, while the other electric capacitor is adapted to reciprocal movement of plates in direction which is transverse to direction of movement of plates of the first, out of two, electric capacitor; at that, all electric capacitors are made in such a manner that instants of time, when sign of movement velocity changes, coincide for all the plates.

2. Device according to claim 1 which is different in that it comprises two electric capacitors with flat plates and is adapted to reciprocal movement of each plate in its plane.

3. Device according to claim 1 which is different in that it comprises three electric capacitors, aligned in a row so that the second electric capacitor is located between the first and third electric capacitors wherein the first and third electric capacitors are adapted to reciprocal movement of flat plates, each in its plane, in longitudinal direction to the row—toward the second electric capacitor and backward, while the second electric capacitor is adapted to reciprocal movement of flat plates, each in its plane, in direction transverse to the row.

4. Device according to claim 1 which is different in that it comprises three electric capacitors, aligned in a row so that the second electric capacitor is located between the first and third electric capacitors wherein the first and third electric capacitors are adapted to reciprocal movement of flat plates, each in its plane, in direction transverse to the row, while the second electric capacitor is adapted to reciprocal movement of flat plates, each in its plane, in longitudinal direction to the row—toward the first electric capacitor and backward or, which is all the same, toward the third electric capacitor and backward.

5. Device according to claim 1 which is different in that it comprises more than three electric capacitors, aligned in a row so that located through one electric capacitors of the first group are adapted to reciprocal movement of flat plates, each in its plane, in longitudinal direction to the row, and electric capacitors of the second group, arranged between them, are adapted to reciprocal movement of flat plates, each in its plane, in direction transverse to the row; wherein, separately in the first group and, similarly, separately in the second group, in transition from one electric capacitor to the successive one, velocity signs of equally charged plates alter.
